(19) United States
(12) Patent Application Publication
(10) Pub. No.: US 2016/0105096 A1
(43) Pub. Date: Apr. 14, 2016

(54) POWER FACTOR CORRECTION CONTROLLER AND POWER SUPPLY APPARATUS USING THE SAME

(71) Applicant: Metal Industries Research & Development Centre, Kaohsiung (TW)

(72) Inventors: Ke-Horng Chen, Hsinchu City (TW); Hsin-Yu Luo, Taoyuan County (TW); Wen-Jiun Liu, Taipei City (TW); Che-Hao Meng, Taipei City (TW); Chih-Wei Chang, Taichung City (TW)

(21) Appl. No.: 14/512,480

(22) Filed: Oct. 13, 2014

(51) Int. Cl. H02M 1/42

(52) U.S. Cl. CPC H02M 1/4225

(57) ABSTRACT

A power factor correction (PFC) controller and a power supply apparatus using the same are provided. The PFC controller includes a driving signal generation circuit and a zero-current prediction circuit. The driving signal generation circuit generates a driving signal to drive a power switch according to a control signal, where the power switch is switched in response to the driving signal, so as to convert an input voltage into an output voltage. The zero-current prediction circuit is coupled to the driving signal generation circuit and performs a capacitance charge/discharge operation, and thus obtains a charge/discharge time characteristic related to a zero-current timing. The zero-current prediction circuit generates the control signal to control operation of the driving signal generation circuit according to the charge/discharge time characteristic.

### BACKGROUND

1. Field of the Invention

The invention is directed to a power conversion technique and more particularly, to a power factor correction (PFC) controller and a power supply apparatus applying the same.

2. Description of Related Art

In recent years, energy shortages have become more and more serious, and therefore, subjects with respect to green power industry has drawn more and more attention from people. Thus, how to design power supply apparatuses with high efficiency is a target that the industry has made efforts to achieve.

In a power supply apparatus, a PFC controller is commonly used to control output of the power supply apparatus, such that the output current generated by the power supply apparatus and an input AC power supply can tend to have the same phase. Thereby, available real power can be optimally applied to achieve an effect of high power factor. Under the current technique, the power supply apparatus is generally operated in a boundary conduction mode (BCM) to allow the power supply apparatus to have high power factor. For the power supply apparatus to be operated in the BCM, a PFC controller has to detect a zero-current time point in a circuit and accordingly control a power conversion operation corresponding thereto, so as to achieve the BCM operation.

However, in order to perform zero-current detection, the current PFC controller designs requires bulky and costly auxiliary winding is required for providing information with respect to the output current and thereby detecting the zero-current time point. However, the use of the auxiliary winding not only cost high and occupies a large circuit area, but also causes inaccuracy in the zero-current detection due to process drifts, which leads to excessive power loss and power factor reduction of the power supply apparatus.

### SUMMARY

The invention provides a power factor correction (PFC) controller and a power supply apparatus applying the same capable of accurately predicting a zero-current time point with auxiliary winding free, so as to achieve a boundary conduction mode (BCM) operation of high power factor correction.

The invention is directed to a power factor correction (PFC) controller, including a driving signal generation circuit and a zero-current prediction circuit. The driving signal generation circuit is configured to generate a driving signal to drive a power switch according to a control signal. The power switch is switched in response to the driving signal, so as to convert an input voltage into an output voltage. The zero-current prediction circuit is coupled to the driving signal generation circuit and configured to perform a capacitance charge/discharge operation according to the driving signal, the input voltage and the output voltage, so as to obtain a charge/discharge time characteristic related to a zero-current time point. The zero-current prediction circuit generates the control signal to control operation of the driving signal generation circuit according to the charge/discharge time characteristic.

In an embodiment of the invention, the zero-current prediction circuit includes a charger unit, a first capacitor, a second capacitor, a comparator and a flip-flop. The charger unit is configured to provide a first charging current and a second charging current according to the driving signal and an inverted driving signal inverting to the driving signal. A first terminal of the first capacitor is coupled to the charger unit to receive the first charging current, and a second terminal of the first capacitor is coupled to a ground terminal. A first terminal of the second capacitor is coupled to the charger unit to receive the second charging current, and a second terminal of the second capacitor is coupled to the ground terminal. A first input terminal of the comparator is coupled to the first terminal of the first capacitor, a second input terminal of the comparator is coupled to the first terminal of the second capacitor, and an output terminal of the comparator generates a charge comparison signal according to charging voltages of the first capacitor and the second capacitor. The flip-flop is coupled to the output terminal of the comparator and configured to generate the control signal according to the charge comparison signal.

In an embodiment of the invention, during an enable period of the driving signal, the charger unit charges the first capacitor in a first charge rate according to the first charging current and charges the second capacitor in a second charge rate according to the second charging current.

In an embodiment of the invention, during a disable period of the driving signal, the charger unit changes to charge the first capacitor in a third charge rate that is different from the first charge rate according to the first charging current and stops charging the second capacitor, and the flip-flop generates an enabled control signal to define an end time of the disable period when the charging voltage of the first capacitor reaches the charging voltage of the second capacitor during a disable period of the driving signal.

In an embodiment of the invention, the charger unit includes a first current source, a second current source, a third current source, a first switch, second switch and a third switch. The first switch is coupled between the first current source and the first terminal of the first capacitor and turned on or turned off in response to the driving signal. The second switch is coupled to the second current source and the first terminal of the second capacitor and turned on or turned off in response to the driving signal. The third switch is coupled between the third current source and the first terminal of the first capacitor and turned on or turned off in response to the inverted driving signal.

In an embodiment of the invention, the zero-current prediction circuit further includes a discharge reset unit. The discharge reset unit is coupled to first capacitor, second capacitor coupled with the first capacitor, the second capacitor and the flip-flop and configured to perform a reset operation on the first capacitor and the second capacitor according to the control signal per cycle end of the driving signal.

In an embodiment of the invention, the PFC controller further includes an overcharge current detection circuit and a charging time adjustment circuit. The overcharge current detection circuit is configured to detect whether a reverse recovery current of a diode coupled to the power switch is over a threshold and generate a plurality of current adjustment signals according to the detection result. The charging time adjustment circuit is coupled to the overcharge current detection circuit and configured to generate a plurality of reference current sources according to the current adjustment signals. The zero-current prediction circuit performs the capacitance charge/discharge operation according to the reference current sources.

In an embodiment of the invention, the overcharge current detection circuit includes an over-voltage detection unit and a current source adjustment unit. The over-voltage detection unit is configured to capture a reference voltage related to the reverse recovery current and compare a level of the reference voltage with a level of a reverse recovery voltage to generate a detection signal according to the comparison result. The current source adjustment unit is coupled to the over-voltage detection unit and configured to generate a plurality of current source adjustment signals according to the detection signal.

In an embodiment of the invention, the charging time adjustment circuit includes an input and output voltage sampling unit, a first current source generator, a second current source generator and a third current source generator. The input and output voltage sampling unit is configured to sample the input voltage and the output voltage so as to generate a first reference current and a second reference current. The first current source generator is coupled to the input and output voltage sampling unit and configured to generate a first current to serve as a first current source according to the first reference current. The second current source generator is coupled to the input and output voltage sampling unit and configured to generate a second current to serve as a second current source according to the first reference current. The third current source generator is coupled to the input and output voltage sampling unit and configured to generate a third current to serve as a third current source according to the first reference current, the second reference current and the current source adjustment signals.

In an embodiment of the invention, the input and output voltage sampling unit includes a first amplifier, a second amplifier, a first transistor, a second transistor, a third transistor, a fourth transistor, a fifth transistor, a sixth transistor, a seventh transistor, an eighth transistor, a first resistor and a second resistor. A first input terminal of the first amplifier receives the input voltage, and a second input terminal of the first amplifier is coupled to an output terminal thereof. A first input terminal of the second amplifier receives the output voltage. A first terminal of the first transistor is coupled to a control terminal thereof, and a second terminal of the first transistor receives a power-supply voltage. A first terminal of the second transistor is coupled to a control terminal thereof, and a second terminal of the second transistor receives the power-supply voltage. A first terminal of the third transistor is coupled to the first terminal of the first transistor, and a control terminal of the third transistor is coupled to the second input terminal of the first amplifier. A first terminal of the fourth transistor is coupled to the first terminal of the second transistor, a second terminal of the fourth transistor is coupled to second input terminal of the second transistor, and a control terminal of the fourth transistor is coupled to the output terminal of the second amplifier. A first terminal of the fifth transistor outputs the second reference current, a second terminal of the fifth transistor receives the power-supply voltage, and a control terminal of the fifth transistor is coupled to the control terminal of the second transistor. A first terminal of the sixth transistor outputs the first reference current, a second terminal of the sixth transistor receives the power-supply voltage, and a control terminal of the sixth transistor is coupled to the control terminal of the first transistor. A first terminal of the seventh transistor is coupled with a control terminal thereof and the first terminal of the fifth transistor, and a second terminal of the seventh transistor is coupled to the ground terminal. A first terminal of the eighth transistor is coupled to the first terminal of the sixth transistor, a second terminal of the eighth transistor is coupled to the ground terminal, and a control terminal of the eighth transistor is coupled to the control terminal of the seventh transistor. The first resistor is coupled between the second terminal of the third transistor and the ground terminal. The second resistor is coupled between the second terminal of the fourth transistor and the ground terminal.

In an embodiment of the invention, the first current source generator includes a ninth transistor. A first terminal of the ninth transistor outputs the first current, a second terminal of the ninth transistor receives the power-supply voltage, and a control terminal of the ninth transistor is coupled to the control terminal of the first transistor.

In an embodiment of the invention, the second current source generator includes a tenth transistor. A first terminal of the tenth transistor outputs the second current, a second terminal of the tenth transistor receives the power-supply voltage, and a control terminal of the tenth transistor is coupled to the control terminal of the first transistor.

In an embodiment of the invention, the third current source generator includes an eleventh transistor, a twelfth transistor and a plurality of current adjustment transistors. A first terminal of the eleventh transistor is coupled with a control terminal thereof and the first terminal of the sixth transistor, and a second terminal of the eleventh transistor receives the power-supply voltage. A first terminal of the twelfth transistor outputs the output current, a second terminal of the twelfth transistor receives the power-supply voltage, and a control terminal of the twelfth transistor is coupled to the control terminal of the eleventh transistor. First terminals of the current adjustment transistors are coupled in common to the first terminal of the twelfth transistor, second terminals of the current adjustment transistors respectively receive the power-supply voltage, and control terminals of the current adjustment transistors respectively receive the current source adjustment signals. Each of the current adjustment transistors generates an adjustment current in response to one of the current source adjustment signals corresponding thereto. The third current source generator serves a sum of the output current and the adjustment currents as the third current.

In an embodiment of the invention, the third, the fourth, the seventh and the eighth transistors are N-type transistors, the others are P-type transistors, the first terminal of each of the transistors is a drain, the second terminal of each of the transistors is a source, and the control terminal of each of the transistors is a gate.

The invention is directed to a power supply apparatus, including an input-stage circuit, a power-stage circuit and a PFC controller. The input-stage circuit is configured to convert an AC power supply into an input voltage. The power-stage circuit includes a power switch, inductor and a diode. The power-stage circuit is coupled to the input-stage circuit via the inductor and coupled to a load via the diode. The power switch is switched in response to a driving signal, so as to convert the input voltage into an output voltage and provide the output voltage to the load. The PFC controller is coupled with the input-stage circuit and the power-stage circuit and includes a driving signal generation circuit and a zero-current prediction circuit. The driving signal generation circuit is configured to generate the driving signal to drive the power switch according to the control signal. The zero-current prediction circuit is coupled to the driving signal generation circuit and configured to perform a capacitance charge/discharge operation according to the driving signal, the input voltage and the output voltage, so as to obtain a charge/discharge time characteristic related to a zero-current time point of the inductor. The zero-current prediction circuit generates the control signal to control operation of the driving signal generation circuit according to the charge/discharge time characteristic.

In an embodiment of the invention, the power supply apparatus is auxiliary winding free.

To sum up, a PFC controller and a power supply apparatus applying the same are provided according to the embodiments of the invention. The PFC controller can accurately predict the zero-current time point by using information, such as the input voltage, the output voltage and the driving signal cycle according to the charge/discharge time characteristics of the capacitors, with auxiliary winding free, such that the power supply apparatus can be operated in the BCM to increase the power factor. Moreover, the embodiments of the invention further provide the current source adjustment mechanism and circuits for compensating device/characteristic/process drifts, and thereby, the zero-current time point can be predicted with more accuracy.

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a power supply apparatus according to an embodiment of the invention.

FIG. 2 is a schematic circuit structure diagram of the zero-current prediction circuit according to an embodiment of the invention.

FIG. 3 is a schematic timing diagram of charging voltages of the first capacitor and the second capacitor according to an embodiment of the invention.

FIG. 4 is a schematic diagram of a power supply apparatus according to another embodiment of the invention.

FIG. 5 is a schematic graph showing the relation between the inductor current and the reverse recovery voltage according to an embodiment of the invention.

FIG. 6 is a schematic circuit structure diagram of a charging time adjustment circuit according to an embodiment of the invention.

### DESCRIPTION OF EMBODIMENTS

In order to make the content of the invention clearer, the following embodiments are illustrated as examples that can be truly implemented by the invention. Wherever possible, the same reference numbers are used in the drawings and the description to refer to the same or like elements/parts/steps.

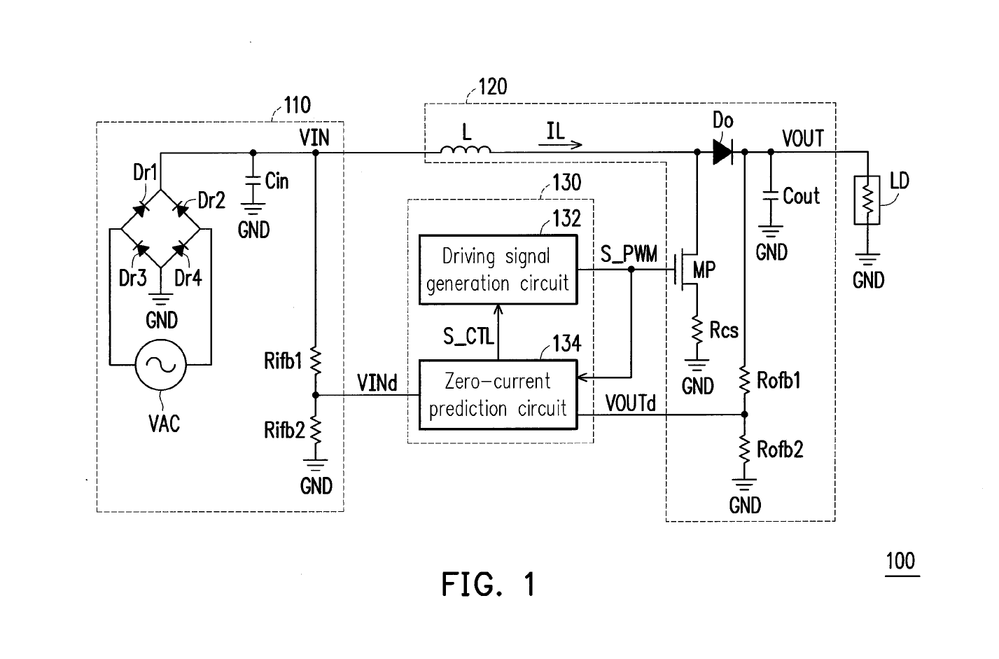

FIG. 1 is a schematic diagram of a power supply apparatus according to an embodiment of the invention. With reference to FIG. 1, a power supply apparatus 100 of the present embodiment includes an input-stage circuit 110, a power-stage circuit 120 and a power factor correction (PFC) controller 130. The input-stage circuit 110 may be configured to convert an AC power supply VAC into an input voltage VIN. The power-stage circuit 120 is coupled to the input-stage circuit 110. The power-stage circuit 120 charges/discharges a resonator component (e.g., an inductor L) according to the input voltage VIN by means of switching, so as to convert the input voltage VIN into an output voltage VOUT. The PFC controller 130 is configured to control the switching of the power-stage circuit 120 according to information, such as the input voltage VIN, the output voltage VOUT and a driving timing sequence of the power-stage circuit 120, such that the power-stage circuit 120 may be operated in a boundary conduction mode (BCM) (that is, the power-stage circuit 120 is switched only when a current of the resonator component is discharged to zero current) to improve a power factor of the power supply apparatus 100.

In detail, the input-stage circuit 110 may be implemented by a circuit structure composed of a rectifier circuit (e.g., a bridge rectifier formed by diodes Dr1 to Dr4), a capacitor Cin and resistors Rifb1 and Rifb2. The rectifier circuit may rectify the received AC power supply VAC, so as to generate the input voltage VIN. Additionally, by means of dividing voltages of the resistors Rifb1 and Rifb2, the input-stage circuit 110 may generate a divided voltage VINd related to the input voltage VIN to the PFC controller 130 for controlling.

The power-stage circuit 120 may be implemented by a power switch MP, inductor L, resistors Rcs, Rfb1 and Rfb2 and a capacitor Cout. A first terminal of the inductor L is coupled to the input-stage circuit 110 to receive the input voltage Vin. A first terminal (drain) of the power switch MP is coupled to a second terminal of the inductor L. A second terminal (source) of the power switch MP is coupled to a ground terminal GND via the resistor Rcs, and a control terminal (gate) of the power switch MP is coupled to the PFC controller 130 to receive a driving signal S_PWM. An anode of a diode Do is coupled with the second terminal of the inductor L and the first terminal of the power switch MP, and a cathode of the diode Do is coupled to a load LD. Additionally, similar to the input-stage circuit 110, the power-stage circuit 120 may also divide the output voltage VOUT through resistors Rofb1 and Rofb2, so as to generate a divided voltage VOUTd related to the output voltage VOUT to the PFC controller 130 for controlling.

The PFC controller 130 includes a driving signal generation circuit 132 and a zero-current prediction circuit 134. The driving signal generation circuit 132 is configured to generate a driving signal S_PWM (e.g., a PWM signal) to drive the power switch MP according to the control signal S_CTL generated by the zero-current prediction circuit 134. Thereby, the power switch MP is switched in response to the driving signal S_PWM, and the inductor L is charged/discharged according to the switching of the power switch MP, such that the input voltage VIN is converted into the output voltage VOUT.

The zero-current prediction circuit 134 is coupled with the input-stage circuit 110, the power-stage circuit 120 and the driving signal generation circuit 132. In the present embodiment, the zero-current prediction circuit 134 performs a capacitance charge/discharge operation on capacitors therein (which are not shown, and the structure of the zero-current prediction circuit will further be specifically described in the embodiments below) according to the driving signal S_PWM, the divided voltage VINd related to the input voltage VIN and the divided voltage VOUTd related to the output voltage VOUT, so as to obtain a charge/discharge time characteristic related to a zero-current time point. The aforementioned zero-current time point refers to a time point at which a current IL of the inductor L is dropped down to zero. Thereby, the zero-current prediction circuit 134 may generate the control signal S_CTL to control operation of the driving signal generation circuit 132 according to the charge/discharge time characteristic, such that the entire power supply apparatus 100 may be operated in the BCM to increase the power factor.

To be more specific, since the zero-current prediction circuit 134 of the present embodiment calculates/predicts a theoretical value of the zero-current time point provided with the specified input voltage VIN by obtaining the information with respect to the input voltage VIN and the output voltage VOUT and according to the charge/discharge time characteristic of the capacitor, the power supply apparatus 100 of the present embodiment may detect the zero-current time point without additionally disposing any auxiliary winding. Thereby, an area of overall circuit designed for the power supply apparatus may be effectively reduced.

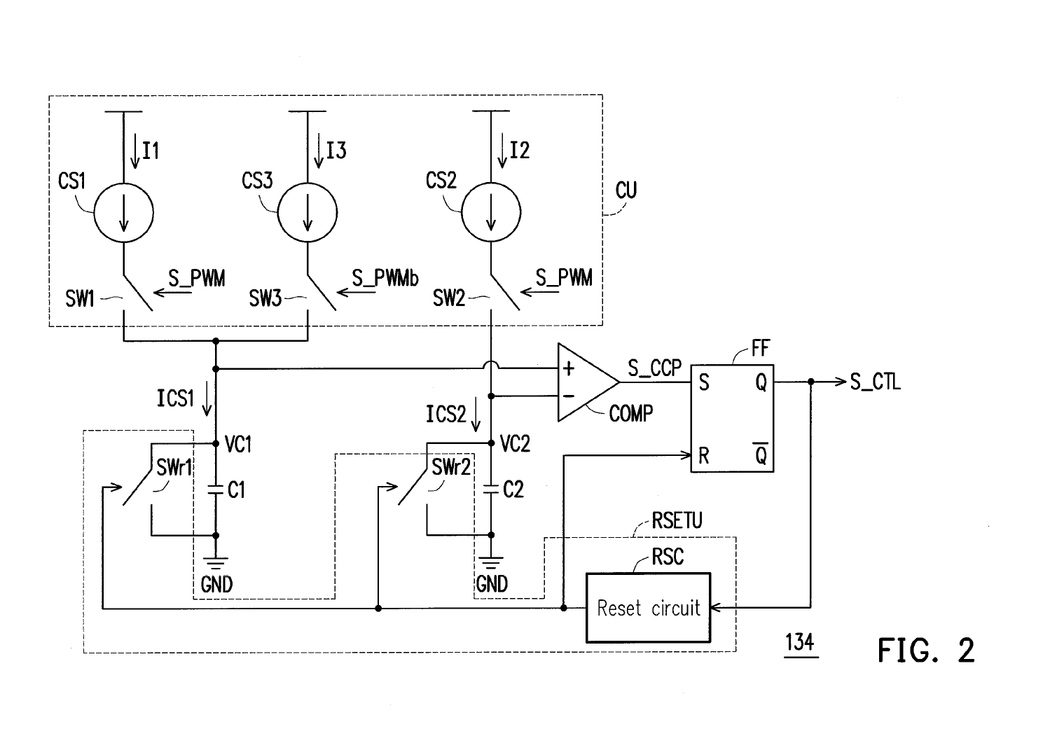

FIG. 2 is a schematic circuit structure diagram of the zero-current prediction circuit according to an embodiment of the invention. With reference to FIG. 2, the zero-current prediction circuit 134 includes a charger unit CU, a first capacitor C1, a second capacitor C2, a comparator COMP, a flip-flop FF and a discharge reset unit RSETU. The charger unit CU is configured to provide a first charging current ICS1 and a second charging current ICS2 according to the driving signal S_PWM and an inverted driving signal S_PWMb inverting to the driving signal S_PWM. The first capacitor C1 is coupled between the charger unit CU and the ground terminal GND, so as to receive the first charging current ICS1 from the charger unit CU. The second capacitor C2 is coupled between the charger unit CU and the ground terminal GND, so as to receive the second charging current ICS2 from the charger unit CU. A positive input terminal and a negative input terminal of the comparator COMP are respectively coupled to a first terminal of the first capacitor C1 and a first terminal of the second capacitor C2, so as to compare levels of charging voltages VC1 and VC2 of the first capacitor C1 and the second capacitor C2. An output terminal of the comparator COMP generates a charge comparison signal S_CCP according to a result of comparing the charging voltages VC1 and VC2. A data-input terminal (S terminal) of the flip-flop FF (an SR flip-flop is illustrated herein for example) is coupled to the output terminal of the comparator COMP to receive the charge comparison signal S_CCP and generate the control signal S_CTL according to the charge comparison signal S_CCP.

To be more specific, the charger unit CU of the present embodiment includes, for example, current sources CS1 to CS3 and switches SW1 to SW3. The current sources CS1, CS2 and CS3 are respectively connected in serial with the switches SW1, SW2 and SW3. The current sources CS1 and CS3 are coupled to the first terminal of the first capacitor C1 respectively via the switches SW1 and SW3, and the current source CS2 is coupled to the first terminal of the second capacitor C2 via the switch SW2.

In the present embodiment, the switches SW1 and SW2 are controlled by the driving signal S_PWM to be turned on or turned off, and the switch SW3 is controlled by the inverted driving signal S_PWMb to be turned on or turned off. When the switches SW1 and SW2 are turned on in response to the driving signal S_PWM, the switch SW3 is correspondingly turned off in response to the inverted driving signal S_PWMb. In this scenario, the charger unit CU serves a current I1 provided by the current source CS1 as the first charging current ICS1 and serves a current I2 provided by the current source CS2 as the second charging current ICS2. On the other hand, when the switches SW1 and SW2 are turned off in response to the driving signal S_PWM, the switch SW3 is correspondingly turned on in response to the inverted driving signal S_PWMb. In this scenario, the charger unit CU serves a current I3 provided by the current source CS3 as the first charging current ICS1.

The discharge reset unit RSETU is coupled with the first capacitor C1, the second capacitor C2 and the flip-flop FF. The discharge reset unit RSETU may perform a reset operation on the first capacitor C1 and the second capacitor C2 according to the control signal S_CTL per cycle end of the driving signal S_PWM. To be more specific, in the present embodiment, the discharge reset unit RSETU includes, for example, a reset circuit RSC and switches SWr1 and SWr2. The switches SWr1 and SWr2 are respectively connected in parallel with the first capacitor C1 and the second capacitor C2, and both the switches SWr1 and SWr2 are controlled by the reset circuit RSC to be turned on or turned off. When the flip-flop FF sends the control signal S_CTL for enabling (which indicates a time point of the cycle end of the driving signal S_PWM), and the reset circuit RSC sends an enabling reset signal to simultaneously reset the flip-flop FF and turn on the switches SWr1 and SWr2, such that electricity stored in the first capacitor C1 and the second capacitor C2 may be rapidly discharged to the ground terminal GND to prevent charge/discharge time characteristics of the first capacitor C1 and the second capacitor C2 from being affected during each cycle.

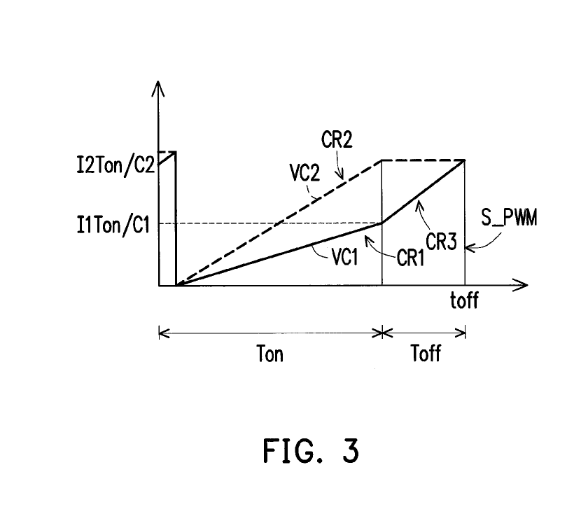

The specific operation of the zero-current prediction circuit 134 will be described with reference to timing sequence depicted in FIG. 3 below. FIG. 3 is a schematic timing diagram of charging voltages of the first capacitor CS1 and the second capacitor CS2 during a cycle of the driving signal S_PWM.

With reference to both FIG. 2 and FIG. 3, first, during an enable period Ton of the driving signal S_PWM (in this case, a low-level driving signal S_PWM is used to indicate enabling, but the invention is not limited thereto), the switches SW1 and SW2 are turned on in response to the enabling driving signal S_PWM, and the switch SW3 is turned off in response to the disabling inverted driving signal S_PWMb. In this scenario, the first capacitor C1 and the second capacitor C2 are charged respectively according to the currents I1 and I2, such that the levels of the charging voltages VC1 and VC2 are gradually boosted. Since the current I2 and the current I1 are designed to have a proportional relation (e.g., the current I2 is twice the current I1), the first capacitor C1 and the second capacitor C2 have different charge rates during the enable period Ton of the driving signal S_PWM (i.e., the charging voltages VC1 and VC2 have different slopes during the enable period Ton). Thus, at the end of the enable period To, the level of the charging voltage VC1 is I1×Ton/C1, and the level of the charging voltage VC2 is I2×Ton/C2. In other words, during the enable period of the driving signal S_PWM, the charger unit CU charges the first capacitor C1 in a first charge rate CR1 according to the first charging current ICS1 (which is I1 in this case) and charges the second capacitor C2 in a second charge rate CR2 according to a second charging current ICS2 (which is I2 in this case).

Then, when the timing sequence of the driving signal S_PWM enters a disable period Toff (in this case, a high-level driving signal S_PWM is used to indicate disabling, but the invention is not limited thereto), the switches SW1 and SW2 are turned off in response to the disabling driving signal S_PWM, and the switch SW3 is turned on in response to the enabling driving signal S_PWM. In this scenario, the first capacitor C1 is charged according to a current I3 provided by the current source CS3, and the second capacitor C2 stops from being charged. In this case, since the current I3 provided by the current source CS3 is identical to the current I2 provided by the current source CS2, the charging voltage VC1 is changed to be gradually boosted in a third charge rate CR3 during the disable period Toff. Therein, the third charge rate CR3 is different from the first charge rate CR1 (but may be identical to the second charge rate CR2, which is not limited in the invention). On the other hand, the charging voltage VC2 is continuously maintained at the voltage level of I2×Ton/C2 during the disable period Toff.

When the charging voltage VC1 is gradually boosted to the level of the charging voltage VC2, the comparator COMP generates the charge comparison signal S_CCP for enabling to instruct the flip-flop FF to generate the control signal S_CTL for enabling, where the control signal S_CTL may be a pulse signal, for example. The driving signal generation circuit 132 then switches the generated driving signal S_PWM to be enabled according to the enabling control signal S_CT. In other words, the driving signal generation circuit 132 defines an end time point toff (which is the time point of the cycle end of the driving signal S_PWM) of the disable period Toff according to the enabling control signal S_CTL and thereby, determines a time length of the disable period Toff.

In the present embodiment, since a time calculated for the charging voltage VC1 being boosted to the level of the charging voltage VC2 is identical to the zero-current time point of the inductor current IL under the structure of the zero-current prediction circuit 134, a transition time point of the driving signal S_PWM determined according to the charge/discharge time characteristics of the capacitors C1 and C2 facilitates in switching the power switch MP accurately at the zero-current time point of the inductor current IL, so as to achieve the operation of the BCM.

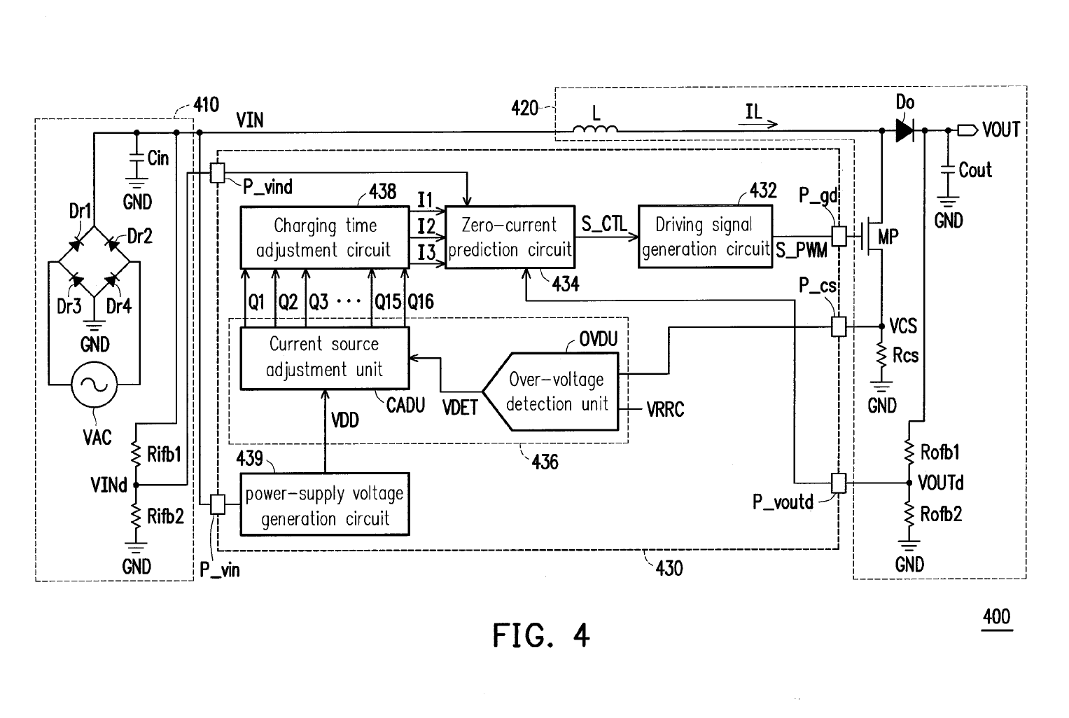

FIG. 4 is a schematic diagram of a power supply apparatus according to another embodiment of the invention. With reference to FIG. 4, a power supply apparatus 400 includes an input-stage circuit 410, a power-stage circuit 420 and a PFC controller 430. In the present embodiment, structures and operations of the input-stage circuit 410 and the power-stage circuit 420 are substantially the same as those of the embodiment illustrated in FIG. 1 and thus, will not be repeatedly described. The difference between the power supply apparatus 400 of the present embodiment and the power supply apparatus 100 of the preceding embodiment mainly lies in the design of the PFC controller 430. To be more specific, the PFC controller 430 of the present embodiment may be implemented in a form of a control chip, for example, and include a plurality of pins P_vind, P_vin, P_gd, P_cs and P_vout. Each of the pins P_vind, P_vin, P_gd, P_cs and P_vout is connected with nodes corresponding to the input-stage circuit 410 and the power-stage circuit 420 which are located externally and thereby, capture information required by the PFC controller 430.

The PFC controller 430 includes not only a driving signal generation circuit 432 and a zero-current prediction circuit 434, but also an overcharge current detection circuit 436, a charging time adjustment circuit 438 and a power-supply voltage generation circuit 439. Specific structures and operations of the driving signal generation circuit 432 and the zero-current prediction circuit 434 are similar to those of the embodiment illustrated in FIG. 1 through FIG. 3. The zero-current prediction circuit 434 may probably cause the issue of failing to accurately indicate the zero-current time point according to the charge/discharge time characteristics due to unexpected factors, such as process drifts, and therefore, the structures of the overcharge current detection circuit 436 and the charging time adjustment circuit 438 are provided by the present embodiment to improve the aforementioned issue. Description with respect to the overcharge current detection circuit 436 and the charging time adjustment circuit 438 will be further set forth below.

In the PFC controller 430, when inaccuracy of zero-current prediction occurs to the zero-current prediction circuit 434 due to process mismatch or process drifts, part of the inductor current IL is led to enter a continuous conduction mode (CCM). As a result, the entire power factor of the power supply apparatus 400 is reduced. The overcharge current detection circuit 436 of the present embodiment determines whether the result of predicting the zero-current is accurate by detecting a reference voltage VCS induced on the resistor Rcs by the reverse recovery current occurred on the diode Do, so as to control the charging time adjustment circuit 438 to adjust sizes of the currents I1, I2 and I3 used by the zero-current prediction circuit 434 for charging/discharging the capacitors. In this way, the control mechanism of correspondingly adjusting the charge/discharge time characteristics according to devices characteristics can be achieved.

In detail, the overcharge current detection circuit 436 may detect whether the reverse recovery current of the diode Do is over a threshold according to the reference voltage VCS captured from the pin P_cs and generate a plurality of current adjustment signals Q1 to Q16 (e.g., digital signals of 16 bits) according to the detection result. The charging time adjustment circuit 438 is coupled to the overcharge current detection circuit 436 to receive the current adjustment signals Q1 to Q16. The charging time adjustment circuit 438 generates a plurality of reference current sources according to the received current adjustment signals Q1 to Q16, and the zero-current prediction circuit 434 performs the capacitance charge/discharge operation according to the reference current sources. In other words, with reference to the embodiment illustrated in FIG. 2, the current sources CS1, CS2 and CS3 of the zero-current prediction circuit 434 of the present embodiment are not constant current sources, but variable current sources which are generated by the charging time adjustment circuit 438 and may cause changes to the sizes of the currents I1 to I3 according to the current adjustment signals Q1 to Q16.

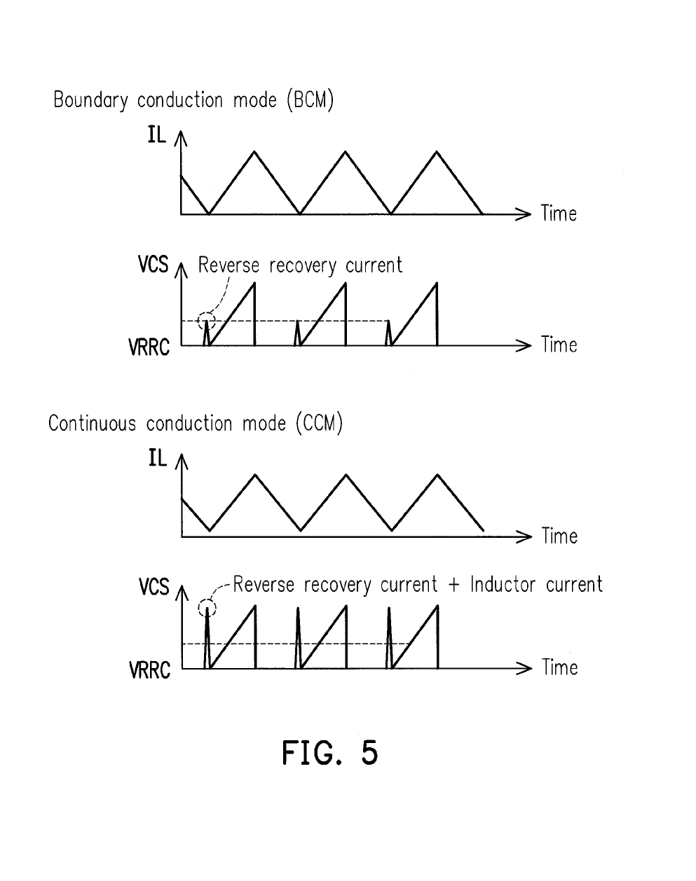

To be more specific, the overcharge current detection circuit 436 includes an over-voltage detection unit OVDU and a current source adjustment unit CADU. The over-voltage detection unit OVDU is configured to capture the reference voltage VCS related to the reverse recovery current of the diode Do, compare a level of the reference voltage VCS and a level of the reverse recovery voltage VRRC and generate a detection signal VDET according to the comparison result. Description with respect to operating principle of the over-voltage detection unit OVDU is set forth with reference to FIG. 5 below. FIG. 5 is a schematic graph showing the relation between the inductor current and the reverse recovery voltage according to an embodiment of the invention.

With reference to both FIG. 4 and FIG. 5, in case the power supply apparatus 400 is operated in the BCM, the reference voltage VCS created by the reverse recovery current of the diode Do is lower than a predetermined reverse recovery voltage VRRC. In this scenario, the over-voltage detection unit OVDU generates the detection signal VDET for disabling to instruct that the current source sizes of the zero-current prediction circuit 434 do not have to be adjusted at present. On the other hand, in case the power supply apparatus 400 is operated in the CCM, the reference voltage VCS is composed of not only the voltage created by the reverse recovery current of the diode Do, but also the voltage created by the surplus inductor current IL, such that the reference voltage VCS in the CCM is higher than the predetermined reverse recovery voltage VRRC. Thereby, the over-voltage detection unit OVDU may generate the detection signal VDET to indicate whether the power supply apparatus 400 is operated in the BCM according to a result of comparing a level of the reference voltage VCS with a level of the reverse recovery voltage VRRC.

The current source adjustment unit CADU is coupled to the over-voltage detection unit OVDU to receive the detection signal VDET. The current source adjustment unit CADU generates the current source adjustment signals Q1 to Q16 according to the detection signal VDET, such that the charging time adjustment circuit 438 may adjust the sizes of the currents I1 to I3 generated by the current source adjustment signals Q1 to Q16. The current source adjustment unit CADU may be implemented by means of a current source adjuster (not shown) and a plurality of D-type flip-flops (not shown), but the invention is not limited thereto. Additionally, the power-supply voltage generation circuit 439 of the present embodiment may generate a power-supply voltage VDD to be used by the current source adjustment unit CADU and the charging time adjustment circuit 438 according to the input voltage VIN.

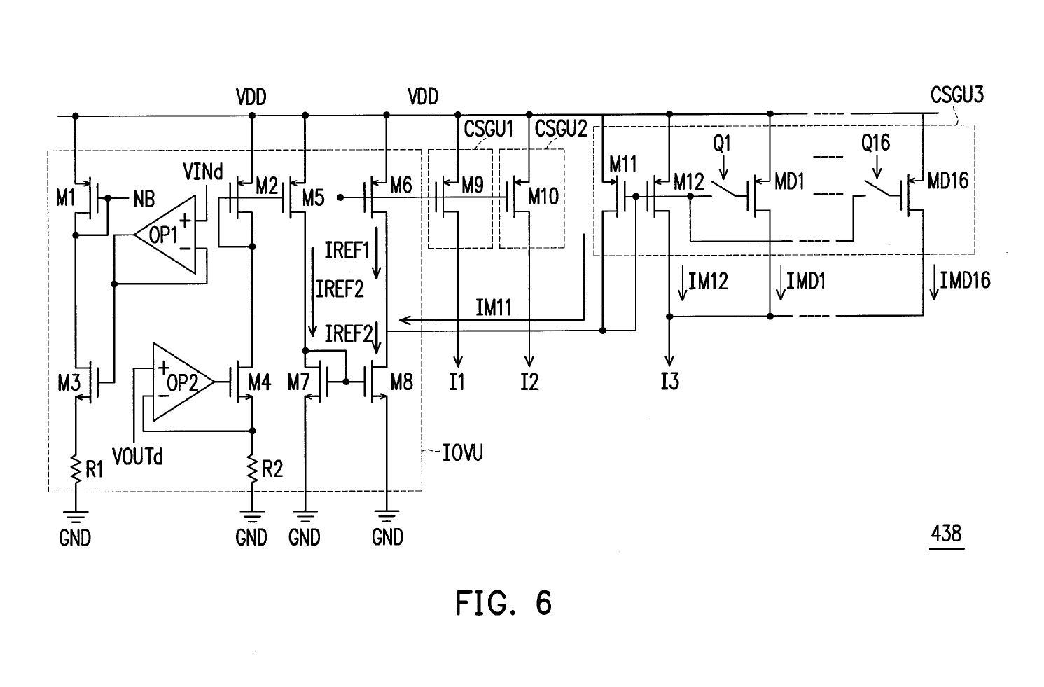

An example of a circuit structure of the charging time adjustment circuit 438 of the present embodiment will be described with reference to FIG. 6. With reference to FIG. 2 and FIG. 6, the charging time adjustment circuit 438 includes an input and output voltage sampling unit IOVU, a first current source generator CSGU1, a second current source generator CSGU2 and a third current source generator CSGU3. The input and output voltage sampling unit is configured to sample the voltage VINd related to the input voltage VIN and the voltage VOUTd related to the output voltage VOUT, so as to generate reference currents IREF1 and IREF2. The first current source generator CSGU1 is coupled to the input and output voltage sampling unit IOVU, so as to generate a current I1 to serve as the current source CS1 of the zero-current prediction circuit (134, 434) according to the reference current IREF1. The second current source generator CSGU2 is coupled to the input and output voltage sampling unit IOVU and configured to generate a current I2 to serve as the current source CS2 of the zero-current prediction circuit (134, 434) according to the reference current IREF1. The third current source generator CSGU3 is coupled to the input and output voltage sampling unit IOVU and configured to generate a current I3 to serve as the current source CS3 of the zero-current prediction circuit according to the reference currents IREF1 and IREF2 and the current source adjustment signals Q1 to Q16.

In the present embodiment, the input and output voltage sampling unit IOVU may be implemented by means of a circuit structure composed of amplifiers OP1 and OP2, transistors M1 to M8 and resistors R1 and R2 (but the invention is not limited thereto). The transistors M1, M2, M5 and M6 are illustrated as P-type transistors as examples, and the transistor M3, M4, M7 and M8 are illustrated as N-type transistors as examples, which construe no limitations to the invention. Additionally, the resistor R1 and the resistor R2 have the same resistance R in the present embodiment.

In detail, a positive input terminal of the amplifier OP1 receives the divided voltage VINd, and a negative input terminal of the amplifier OP1 is coupled to an output terminal of the amplifier OP1. A positive input terminal of the amplifier OP2 receives the divided output voltage VOUTd. A drain of the transistor M1 is coupled to a gate thereof, and a source of the transistor M1 receives the power-supply voltage VDD. A drain of the transistor M2 is coupled to a gate thereof, and a source of the transistor M2 receives the power-supply voltage VDD. A drain of the transistor M3 is coupled with the drain and the gate of the transistor M1, a gate of the transistor M3 is coupled with the negative input terminal and the output terminal of the amplifier OP1. A drain of the transistor M4 is coupled with the drain and the gate of the transistor M2, a source of the transistor M4 is coupled to the negative input terminal of the amplifier OP2, and a gate of the transistor M4 is coupled to the output terminal of the amplifier OP2. A drain of the transistor M5 outputs the reference current IREF2, a source of the transistor M5 receives the power-supply voltage VDD, and a gate of the transistor M5 is coupled to the gate of the transistor M2. A drain of the transistor M6 outputs the reference current IREF1, a source of the transistor M6 receives the power-supply voltage VDD, and a gate of the transistor M6 is coupled to the gate (node NB) of the transistor M1. A drain of the transistor M7 is coupled with a gate thereof and the drain of the transistor M5, and a source of the transistor M7 is coupled to the ground terminal GND. A drain of the transistor M8 is coupled to the drain transistor M6, a source of the transistor M8 is coupled to ground terminal GND, and a gate of the transistor M8 is coupled to gate of the transistor M7. The resistor R1 is coupled between the source of the transistor M3 and the ground terminal GND. The resistor R2 is coupled between the source of the transistor M4 and the ground terminal GND.

The first current source generator CSGU1 and the second current source generator CSGU2 may be respectively formed by a transistor M9 and a transistor M10 (which are illustrated as P-type transistors as exemplary implementation examples, but the invention is not limited thereto). Gates of the transistors M9 and M10 are coupled in common to the node NB (i.e., the gates of the transistors M1 and M6), and sources of the transistors M9 and M10 receive the power-supply voltage VDD. With the configuration, the reference current IREF1 is mapped to the transistors M9 and M10 respectively, such that drains of the transistors M9 and M10 output the output currents I1 and I2 respectively. Device sizes of the transistor M9 and M10 may be designed to have a certain proportion, such that the currents I1 and I2 are correspondingly proportional to each other.

The third current source generator CSGU3 may be formed by transistors M11 and M12 and current adjustment transistors MD1 to MD16, where the transistors M11 and M12 and the current adjustment transistors MD1 to MD16 are illustrated as P-type transistors as exemplary implementation examples, but the invention is not limited thereto. A drain of the transistor M11 is coupled with a gate thereof and the first terminal of the transistor M6, and a source of the transistor M11 receives the power-supply voltage VDD. A current IM11 output by the transistor M11 is equal to the reference current IREF2 deducting the reference current IREF1. In the present embodiment, the reference current IREF1 is VINd/R, the reference current IREF2 is VOUTd/R, and thus, the current output by the transistor M11 is (VOUTd-VINd)/R. A source of the transistor M12 receives the power-supply voltage VDD, and a gate of the transistor M12 is coupled to the control terminal transistor M11. The output current IM11 of the transistor M11 is mapped to the transistor M12, such that a drain of the transistor M12 outputs an output current IM12. Drains of the current adjustment transistors MD1 to MD16 are coupled in common to the drain of the transistor M12, sources of the current adjustment transistors MD1 to MD16 respectively receive the power-supply voltage VDD, and gates of the current adjustment transistors MD1 to MD16 respectively receive the current source adjustment signals Q1 to Q16 provided by the current source adjustment unit CADU and are respectively turned on or turned off in response to the corresponding current source adjustment signals Q1 to Q16.

With the configuration, the current adjustment transistors MD1 to MD16 respectively generate adjustment currents IMD1 to IMD16 in response to the corresponding current source adjustment signals Q1 to Q16, and thus, the third current source generator CSGU3 serves a sum of the output current IM12 of the transistor M12 and the adjustment currents IMD1˜IMD16 of the current adjustment transistors MD1 to MD16 as the current I3. Thereby, the control mechanism of providing different current sources dynamically according to the different current source adjustment signals Q1 to Q16 can be achieved through circuit combination of the input and output voltage sampling unit IOVU, the first current source generator CSGU1, the second current source generator CSGU2 and the third current source generator CSGU3.

In light of the foregoing, the embodiments of the invention provide a PFC controller and a power supply apparatus applying the same. The PFC controller can accurately predict the zero-current time point by using information, such as the input voltage, the output voltage and the driving signal cycle according to the charge/discharge time characteristics of the capacitors, with auxiliary winding free, such that the power supply apparatus can be operated in the BCM to increase the power factor. Moreover, the embodiments of the invention further provide the current source adjustment mechanism and circuits for compensating device/characteristic/process drifts, and thereby, the zero-current time point can be predicted with more accuracy.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A power factor correction (PFC) controller, comprising:
a driving signal generation circuit, configured to generate a driving signal to drive a power switch according to a control signal, wherein the power switch is switched in response to the driving signal, so as to convert an input voltage into an output voltage; and
a zero-current prediction circuit, coupled to the driving signal generation circuit and configured to perform a capacitance charge/discharge operation according to the driving signal, the input voltage and the output voltage, so as to obtain a charge/discharge time characteristic related to a zero-current time point, wherein the zero-current prediction circuit generates the control signal to control operation of the driving signal generation circuit according to the charge/discharge time characteristic.

2. The PFC controller according to claim 1, wherein the zero-current prediction circuit comprises:
a charger unit, configured to provide a first charging current and a second charging current according to the driving signal and an inverted driving signal inverting to the driving signal;
a first capacitor, having a first terminal coupled to the charger unit to receive the first charging current and a second terminal coupled to a ground terminal;
a second capacitor, having a first terminal coupled to the charger unit to receive the second charging current and a second terminal coupled to the ground terminal;
a comparator, having a first input terminal coupled to the first terminal of the first capacitor, a second input terminal coupled to the first terminal of the second capacitor and an output terminal generating a charge comparison signal according to charging voltages of the first capacitor and the second capacitor; and
a flip-flop, coupled to the output terminal of the comparator and configured to generate the control signal according to the charge comparison signal.

3. The PFC controller according to claim 2, wherein the charger unit charges the first capacitor in a first charge rate according to the first charging current and charges the second capacitor in a second charge rate according to the second charging current during an enable period of the driving signal.

4. The PFC controller according to claim 3, the charger unit changes to charge the first capacitor in a third charge rate that is different from the first charge rate according to the first charging current and stops charging the second capacitor, and the flip-flop generates an enabled control signal to define an end time of the disable period when the charging voltage of the first capacitor reaches the charging voltage of the second capacitor during a disable period of the driving signal.

5. The PFC controller according to claim 2, wherein the charger unit comprises:
a first current source;
a second current source;
a third current source;
a first switch, coupled between the first current source and the first terminal of the first capacitor and turned on or turned off in response to the driving signal;
a second switch, coupled between the second current source and the first terminal of the second capacitor and turned on or turned off in response to the driving signal; and
a third switch, coupled between the third current source and the first terminal of the first capacitor and turned on or turned off in response to the inverted driving signal.

6. The PFC controller according to claim 2, wherein the zero-current prediction circuit further comprises:
a discharge reset unit, coupled with the first capacitor, the second capacitor and the flip-flop and configured to perform a reset operation on the first capacitor and the second capacitor according to the control signal per cycle end of the driving signal.

7. The PFC controller according to claim 1, further comprising:
an overcharge current detection circuit, configured to detect whether a reverse recovery current of a diode coupled to the power switch is over a threshold and generate a plurality of current adjustment signals according to the detection result; and
a charging time adjustment circuit, coupled to the overcharge current detection circuit and configured to generate a plurality of reference current sources according to the current adjustment signals, wherein the zero-current prediction circuit performs the capacitance charge/discharge operation according to the reference current sources.

8. The PFC controller according to claim 7, wherein the overcharge current detection circuit comprises:
an over-voltage detection unit, configured to capture a reference voltage related to the reverse recovery current and compare a level of the reference voltage with a level of a reverse recovery voltage to generate a detection signal according to the comparison result; and
a current source adjustment unit, coupled to the over-voltage detection unit and configured to generate a plurality of current source adjustment signals according to the detection signal.

9. The PFC controller according to claim 8, wherein the charging time adjustment circuit comprises:
an input and output voltage sampling unit, configured to sample the input voltage and the output voltage so as to generate a first reference current and a second reference current;
a first current source generator, coupled to the input and output voltage sampling unit and configured to generate a first current to serve as a first current source according to the first reference current;
a second current source generator, coupled to the input and output voltage sampling unit and configured to generate a second current to serve as a second current source according to the first reference current; and
a third current source generator, coupled to the input and output voltage sampling unit and configured to generate a third current to serve as a third current source according to the first reference current, the second reference current and the current source adjustment signals.

10. The PFC controller according to claim 9, wherein the input and output voltage sampling unit comprises:
a first amplifier, having a first input terminal receiving the input voltage and a second input terminal coupled to an output terminal thereof;
a second amplifier, having a first input terminal receiving the output voltage;
a first transistor, having a first terminal coupled to a control terminal thereof and a second terminal receiving a power-supply voltage;
a second transistor, having a first terminal coupled to a control terminal thereof and a second terminal receiving the power-supply voltage;
a third transistor, having a first terminal coupled to the first terminal of the first transistor and a control terminal coupled to the second input terminal of the first amplifier;
a fourth transistor, having a first terminal coupled to the first terminal of the second transistor, a second terminal coupled to the second input terminal of the second transistor and a control terminal coupled to the output terminal of the second amplifier;
a fifth transistor, having a first terminal outputting the second reference current, a second terminal receiving a power-supply voltage and a control terminal coupled to the control terminal of the second transistor;
a sixth transistor, having a first terminal outputting the first reference current, a second terminal receiving the power-supply voltage and a control terminal coupled to the control terminal of the first transistor;
a seventh transistor, having a first terminal coupled with a control terminal thereof and the first terminal of the fifth transistor and a second terminal coupled to the ground terminal;
an eighth transistor, having a first terminal coupled to the first terminal of the sixth transistor, a second terminal coupled to the ground terminal and a control terminal coupled to the control terminal of the seventh transistor;
a first resistor, coupled between the second terminal of the third transistor and a ground terminal; and
a second resistor, coupled between the second terminal of the fourth transistor and the ground terminal.

11. The PFC controller according to claim 10, wherein the first current source generator comprises:
a ninth transistor, having a first terminal outputting the first current, a second terminal receiving the power-supply voltage and a control terminal coupled to the control terminal of the first transistor.

12. The PFC controller according to claim 11, wherein the second current source generator comprises:
a tenth transistor, having a first terminal outputting the second current, a second terminal receiving the power-supply voltage and a control terminal coupled to the control terminal of the first transistor.

13. The PFC controller according to claim 12, wherein the third current source generator comprises:
an eleventh transistor, having a first terminal coupled with a control terminal thereof and the first terminal of the sixth transistor and a second terminal receiving the power-supply voltage;
a twelfth transistor, having a first terminal outputting an output current, a second terminal receiving the power-supply voltage and the control terminal coupled to the control terminal of the eleventh transistor; and
a plurality of current adjustment transistors, having first terminals coupled in common to the first terminal of the twelfth transistor, second terminals respectively receiving the power-supply voltage and control terminals respectively receiving the current source adjustment signals,
wherein each of the current adjustment transistors generates an adjustment current in response to one of the current source adjustment signals corresponding thereto, and the third current source generator serves a sum of the output current and the adjustment currents as the third current.

14. The PFC controller according to claim 13, wherein the third, the fourth, the seventh and the eighth transistors are N-type transistors, the others are P-type transistors, the first terminal of each of the transistors is a drain, the second terminal of each of the transistors is a source, and the control terminal of each of the transistors is a gate.

15. A power supply apparatus, comprising:
an input-stage circuit, configured to convert an AC power supply into an input voltage;
a power-stage circuit, comprising a power switch, an inductor and a diode, coupled to the input-stage circuit via the inductor and coupled to a load via the diode, wherein the power switch is switched in response to a driving signal, so as to convert the input voltage into an output voltage and provide the output voltage to the load; and
a PFC controller, coupled with the input-stage circuit and the power-stage circuit and comprising:
a driving signal generation circuit, configured to generate the driving signal to drive the power switch according to the control signal; and
a zero-current prediction circuit, coupled to the driving signal generation circuit and configured to perform a capacitance charge/discharge operation according to the driving signal, the input voltage and the output voltage, so as to obtain a charge/discharge time characteristic related to a zero-current time point of the inductor, wherein the zero-current prediction circuit generates the control signal to control operation of the driving signal generation circuit according to the charge/discharge time characteristic.

16. The power supply apparatus according to claim 15, wherein the power supply apparatus is auxiliary winding free.

17. The power supply apparatus according to claim 15, wherein the zero-current prediction circuit comprises:
a charger unit, configured to provide a first charging current and a second charging current according to the driving signal and an inverted driving signal inverting to the driving signal;
a first capacitor having a first terminal coupled to the charger unit to receive the first charging current and a second terminal coupled to a ground terminal;
a second capacitor, having a first terminal coupled to the charger unit to receive the second charging current and a second terminal coupled to the ground terminal;
a comparator, having a first input terminal coupled to the first terminal of the first capacitor, a second input terminal coupled to the first terminal of the second capacitor and an output terminal generating a charge comparison signal according to charging voltages of the first capacitor and the second capacitor; and
a flip-flop, coupled to the output terminal of the comparator and configured to generate the control signal according to the charge comparison signal.

18. The power supply apparatus according to claim 15, wherein the PFC controller further comprises:
an overcharge current detection circuit, configured to detect whether a reverse recovery current of the diode is over a threshold and generate a plurality of current adjustment signals according to the detection result; and
a charging time adjustment circuit, coupled to the overcharge current detection circuit and configured to generate a plurality of reference current sources according to the current adjustment signals, wherein the zero-current prediction circuit performs the capacitance charge/discharge operation according to the reference current sources.

19. The power supply apparatus according to claim 18, wherein the overcharge current detection circuit comprises:
an over-voltage detection unit, coupled to the power switch and configured to capture a reference voltage related to the reverse recovery current and compare a level of the reference voltage with a level of a reverse recovery voltage to generate a detection signal according to the comparison result; and
a current source adjustment unit, coupled to the over-voltage detection unit and configured to generate the current source adjustment signals according to the detection signal.

20. The power supply apparatus according to claim 19, wherein the charging time adjustment circuit comprises:
an input and output voltage sampling unit, configured to sample the input voltage and the output voltage so as to generate a first reference current and a second reference current;
a first current source generator, coupled to the input and output voltage sampling unit and configured to generate a first current to serve as a first current source according to the first reference current;
a second current source generator, coupled to the input and output voltage sampling unit and configured to generate a second current to serve as a second current source according to the first reference current; and
a third current source generator, coupled to the input and output voltage sampling unit and configured to generate a third current to serve as a third current source according to the first reference current, the second reference current and the current source adjustment signals.
